(19) United States
(12) Patent Application Publication
(10) Pub. No.: US 2020/0318783 A1
(43) Pub. Date: Oct. 8, 2020

(54) REMOVABLY ATTACHABLE WEATHER PROTECTION SYSTEM

(71) Applicant: Brian Patrick Shillue, JR., Scituate, MA (US)

(72) Inventor: Brian Patrick Shillue, JR., Scituate, MA (US)

(21) Appl. No.: 16/835,496

(22) Filed: Mar. 31, 2020

Related U.S. Application Data
(60) Provisional application No. 62/830,798, filed on Apr. 8, 2019.

(51) Int. Cl. F16M 13/02; A47C 7/66

(52) U.S. Cl. CPC F16M 13/02; A47C 7/664

(57) ABSTRACT

A removable attached bracket for securing weather protection system particularly applicable for beach chairs, deck chairs, garden chairs, chairs frames, the system can easily be attached and transported by the user and easily fits in a beach bag. In one embodiment a bracket apparatus includes a set of arms, and each of the arms includes a through slot and a set of flexible joining mechanisms utilizing “hook & loop” fasteners disposed to communicate with a seating member and to communicate with at least one weather protection member. Thus, the opposite facing nature of the fins also facilitates holding the brackets in place. In an additional embodiment because the curved fins are opposite of one another and the two components are identical in manufacture, thus when assembled, this fabrication produces a universal attachment method.

### CROSS REFERENCE TO RELATED APPLICATION

This application takes priority from and claims the benefit of U.S. Provisional Application Ser. No. 62/830,798 filed on Apr. 8, 2019, the contents of which are herein incorporated by reference.

### BACKGROUND OF THE INVENTION

### Field of the Invention

The present invention relates generally to devices that are used in conjunction with or are all inclusive designs used to provide protection from the sun and wind, and more particularly systems to cover deck chairs, garden chairs, beach chairs with metal frames and the like that is easy to be assembled, disassembled and carried by the user wherever and whenever they like which can also be used in a simple way to protect oneself from the sun or the wind.

### Description of the Related Art

Within the art exist various systems to assist in retaining beach umbrellas and coverings in place using sandbags, platforms, cables and ground stakes. More specifically among the state of the art, one system illustrates an adjustable sunshade with a fabric covered canopy constructed out of a plastic such a polypropylene or out of metal such as aluminum or out of wood. Another system illustrates a canopy which is slidably attached to the back of a chair and which may be adjusted using a tension cap.

An additional system illustrates an adjustable covering for a beach chair in which the fabric canopy is attached to a frame by side members which project from tubular side members on the back of the chair. A system illustrates a fabric covered collapsible canopy which is attached to a chair by attachment means. The canopy includes a cross-coupled truss structure support which collapses for storage.

One system illustrates a folding shelter with a canopy which attaches to a folding chair. The fabric canopy is supported by upper and lower struts which are attached to real rails at the back of the chair. The canopy can be collapsed and stored in a carrying case somewhat longer than a golf bag. Another system illustrates a sunshade for a chair having a rigid visor. The sunshade has a fabric cover which is supported by a U-shaped structure comprised of horizontal support arms and a tubular cross arm. Vertical shade support arms are attached to the back of the chair by clamps.

An additional system illustrates a folding chair with canopy in which the canopy is supported by spacer members which also form the back of the chair and by support members which are pivotally attached to the arm rests. And, one disclosure illustrates a sunshade which is foldable and may be attached to a chair via a novel attachment means which resembles a clamp, while another utilizes two specific end points for attachment one being for the umbrella, another for a fixed object.

One concurrent system features a sand bag and cabling system as an anchoring device along with the need for a shovel. This is troublesome if you are dealing with rocky or hard soil and would require the individual to also have a shovel as well. The sandbag is utilized as a weighting medium for stability. An additional system utilizes an umbrella stand that is buried in the sand while another illustrates a beach umbrella carrying case and anchoring system which is platform based acting as a weighting medium used to hold the umbrella upright, while an additional platform based device utilizes a pole and clamping mechanism to hold the umbrella upright.

Another platform-based support stand that must be buried in the sand in order to be effective. This is troublesome if you are dealing with rocky or hard soil and would require the individual to also have a shovel as well.

And finally, one system features a tie down strapping system requiring the need to drive a stake into the ground and drive the umbrella pole into the sand as well, which could be untenable if the surface was hard pack or rocky in makeup.

The foregoing examples of the related art and limitations related therewith are intended to be illustrative and not exclusive. Other limitations of the related art will become apparent to those of skill in the art upon a reading of the specification and a study of the drawings.

It is worth mentioning apart from the fact that it is undoubtedly a novelty and comfortable to use, it is easy to assemble by simply coupling its parts and compatibility with most metal framed chairs.

The foregoing examples of the related art and limitations related therewith are intended to be illustrative and not exclusive. Other limitations of the related art will become apparent to those of skill in the art upon a reading of the specification and a study of the drawings.

It is worth mentioning apart from the fact that it is undoubtedly a novelty and comfortable to use, it is easy to assemble by simply coupling its parts and compatibility with most framed chairs.

### SUMMARY OF THE INVENTION

The instant apparatus and method, as illustrated herein, is clearly not anticipated, rendered obvious, or even present in any of the prior art mechanisms, either alone or in combination thereof. This versatile system and method facilitate delivery of shade and protection to beach chairs under challenging weather and wind conditions as illustrated. Thus, the several embodiments of the instant apparatus and method are illustrated herein.

This present enhancements to the concurrent art, among the most remarkable advantages of this bracket particularly applicable for deck chairs, garden chairs, beach chairs with metal frames and the like, is the versatility of the system for using the chair for larger scale usage with a bracket to shade multiple people.

This present system allows individuals to utilize the common beach chair and common beach umbrella in tandem by utilizing each apparatus to quickly and easily deploy and secure the umbrella in place. A bracket will be attached to the back of the metal framed chair to ensure the canopy or umbrella to resist most natural elements of nature while providing shade.

It is therefore an objective of the instant apparatus and method for this present system to provide a bracket particularly applicable for deck chairs, garden chairs, beach chairs with metal frames and the like which can be easily attached and detached in the place itself to be used and carried by the user.

It is an additional objective of the instant apparatus to disclose a bracket composed primarily of two cross-hatched halves of tubing which can secure onto the back of an outdoors chair with a metal frame and to a beach umbrella pole, thereby adding to the securing of the beach umbrella into the ground by using the weight of the individual sitting in the chair as to remain planted.

And, it is an objective of the instant apparatus to disclose a bracket that is also universally attachable with the vertical or horizontal arms mutually compatible with either the beach chair back or attached to the umbrella pole.

It is also an objective of the instant apparatus to introduce utilization of a standard and common beach chair as a stabilizing mechanism whereas the beach chair and beach umbrella are utilized in tandem to add support to one another.

It is moreover an objective of the instant apparatus to disclose beach umbrella brackets wherein the attaching surfaces are universal or neutral when attaching the vertical and horizontal arms of the device.

Further, there is a bracket which one may use that attaches to the back of a metal framed chair and will secure a beach umbrella pole to the chair as to provide shade for a greater surrounding area and ensure the umbrella stays firmly planted in the ground.

These together, with the objectives of the devices, along with the various features of novelty, which characterize the apparatus, are pointed out with particularity in the claimed annexed to and forming a part of this disclosure. For a better understanding of the method, its advantages, and the specific objectives attained by its use, the study of accompanying drawings and descriptive matter, in which there are illustrations of the preferred embodiments, should be conducted.

There has thus been outlined, rather broadly, the more important features of the versatile integrated instant method, and series of accompanying systems and apparatuses and embodiments in order that the detailed description thereof that follows may be better understood, and in order that the present contribution to the art may be better appreciated. There are additional features of the invention that may be better appreciated. There are additional features of the invention that will be described hereinafter which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

These together with other objects of the invention, along with various features of novelty, which characterize the invention, are pointed out with particularity in the claimed annexed to and forming a part of this disclosure. For a better understanding of the invention, its operating advantages and the specific objects attained by its uses, reference should be made to the accompanying drawings and descriptive matter in which there are illustrated preferred embodiments of the invention.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of all claimed subject matter. Other advantages and novel features will become apparent from the following detailed description when considered in conjunction with the drawings.

### BRIEF DESCRIPTION OF THE DRAWINGS

FIG. 1 illustrates a front perspective the overall system including the bracket used to latch onto the beach chair frame and hold the beach umbrella firmly in the sand.

FIG. 2 illustrates a right-side perspective view of the overall system including the bracket used to latch onto the beach chair frame and hold the beach umbrella firmly in the sand from a side view perspective.

FIG. 3 illustrates a top plan view the overall system including the bracket used to latch onto the beach chair frame and hold the beach umbrella firmly in the sand from the back view.

FIG. 4 illustrates a front perspective view of the bracket of the instant system, which is used to latch onto the beach chair frame and to hold the beach umbrella firmly in the sand without the hook and loop straps connected to the device.

FIG. 5 illustrates a left side view of the bracket of the instant system which is used to latch onto the beach chair frame and hold the beach umbrella firmly in the sand without the hook and loop straps connected to the device from a side view of the device.

FIG. 6 illustrates the top plan view of the bracket of the instant system which is used to latch onto the beach chair frame and hold the beach umbrella firmly in the sand without the straps connected to the device from the back view.

FIG. 7 illustrates a side view of one arm the bracket including the view of the device used to hold the umbrella pole or the beach chair in place in detailed view of the sides of the individual sides of the device.

FIG. 8 illustrates a top plan view of one arm of the bracket further illustrating the curved sides or fins used to hold the umbrella pole or the beach chair in place are located on opposite sides of the device.

FIG. 9 illustrates front view of one arm of the device wherein with the curved sides or fins turned upwards and the opening through which the straps may be inserted through the device.

FIG. 10 illustrates a side perspective view of the device installed on chair apparatus wherein the umbrella pole runs vertically through the device and secured with straps and the beach chair frame runs horizontally through the device and is being secured with the straps.

FIG. 11 illustrates a side view of the device installed on chair apparatus wherein device wherein the device is being used to attach the umbrella to the beach chair and into the beach sand.

### DETAILED DESCRIPTION OF THE SEVERAL EMBODIMENTS

The detailed description set forth below is intended as a description of the presently preferred embodiments of the system and does not represent the only forms in which the present system may be construed or utilized. The description sets forth the functions and the sequence of the steps for producing the system and accompanying apparatus. However, it is to be understood that the same or equivalent functions and sequences may be accomplished by different embodiments and are also intended to be encompassed within the scope of the system.

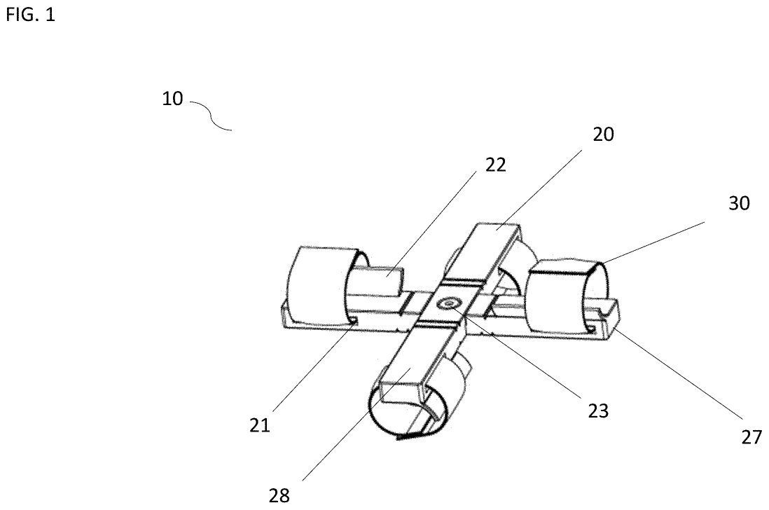

FIG. 1 illustrates a top perspective view the overall system 10 used to latch onto the back of the beach chair wherein the horizontal and vertical arms of the bracket 20 are attached to one another with a standard steel rivet is used to form the body of the bracket 20 wherein there are holes in bracket 21 and a curved portion of the bracket 22 to allow for a hook and loop fastener too be strung through the holes of the bracket 21 in order to be secured. The tension or torsion created from the opposite facing nature of the fins 22 also hold the bracket to each device adding to the securing nature of the device along with the hook and loop strapping 30. Further disclosed are a first arm 27, a second arm 28, and the rivet 23, which may be a standard steel rivet, or any state-of-the-art fastening system, utilized to securely join the first and second arm.

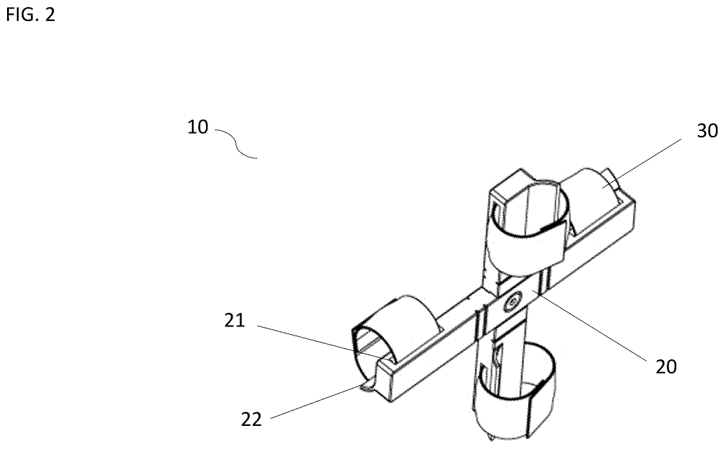

FIG. 2 illustrates a right side view of the overall system 10 used to latch onto the beach chair frame and hold the beach umbrella firmly in the sand and further displays the bracket 20 from a side view perspective wherein one can see the holes or slots in the bracket 21 to allow for the hook and loop fastener 30, such as a Velcro® fixture to be strung around the curved portion of the bracket fins 22.

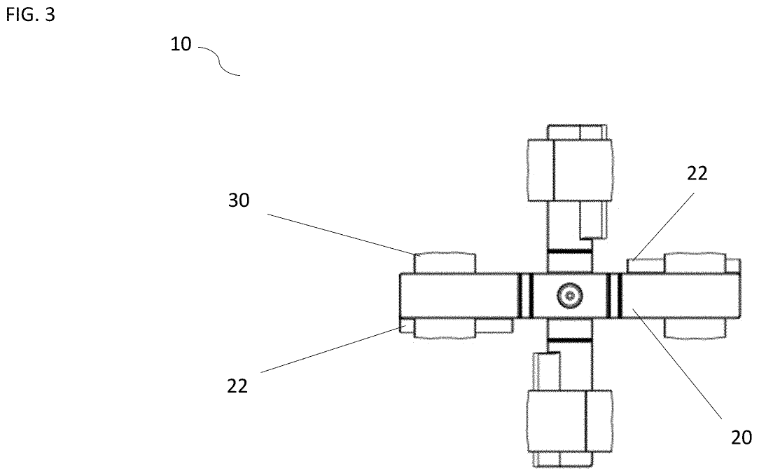

FIG. 3 illustrates a top plan view of the overall system 10 used to latch onto the beach chair frame and hold the beach umbrella firmly in the sand from the back side illustrating the bracket 20 device and further displays the slots or apertures 21 located on the ends of the bracket wherein the curved portion of the bracket fins 22 displays how it wraps around the metal frame of the beach chair or beach umbrella and displays the hook and loop fastener 30 that secures the beach chair frame or umbrella pole to the bracket and into the sand.

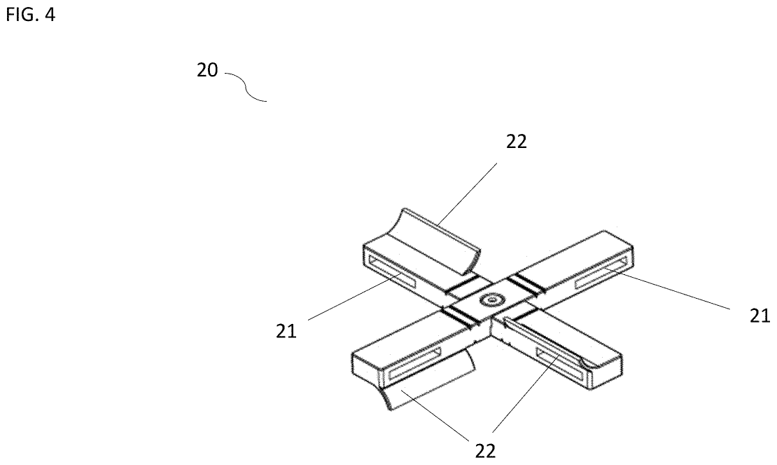

FIG. 4 illustrates a perspective view the overall system 10 used to latch onto the beach chair frame and hold the beach umbrella firmly in the sand and the holes, slot or apertures 21 located in the bracket 20 wherein the curved portion of the device is displayed without the hook and loop fastener 30.

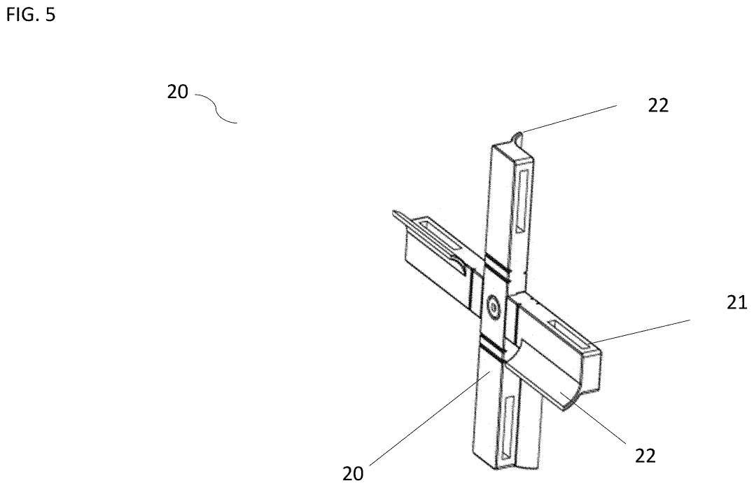

FIG. 5 illustrates a left view the bracket 10 used to latch onto the beach chair frame and the umbrella from an upright position as if the bracket 20 is being held onto the objects and the apertures, holes or slots 21 through the device where the curved portion of the device 22 allows the poles of either the beach chair or the umbrella will fit securely within the device as to hold the poles in place without the hook and loop fastener 30 displayed in this drawing.

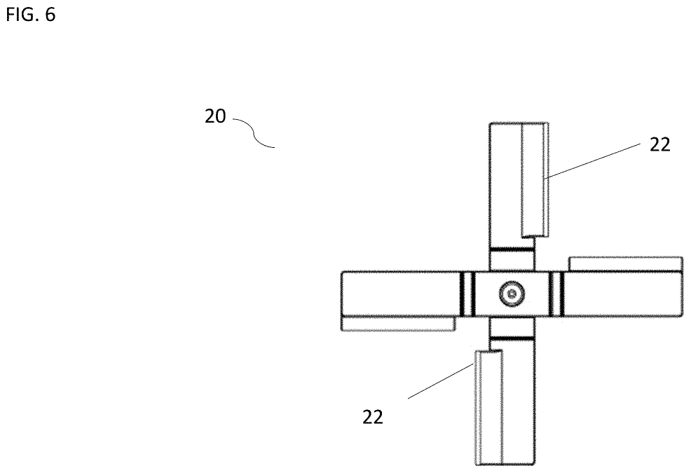

FIG. 6 illustrates a top plan view of the overall system 10 wherein the body of the bracket 20 displays the holes on the brackets 21 that go through the ends of each side of the bracket and the curved portion of the bracket 22 is on one side of the bracket to allow a hook and loop fastener 30 to secure the beach chair frame to the umbrella that is not shown in this drawing.

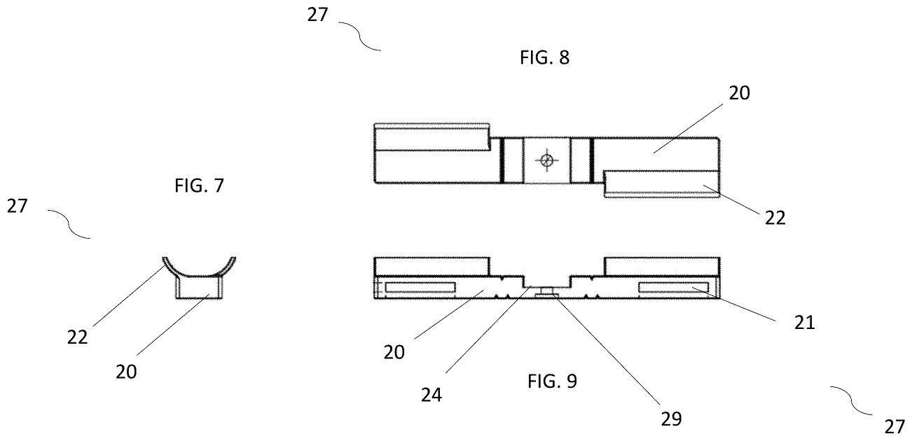

FIG. 7 illustrates a side view of the first arm 27 of the bracket 10 from the end of the device 20 wherein the curved portions of the device 22 are displayed as too allow for a closer view as to how this portion wraps around the beach chair frame or umbrella pole and its dimensions. The dimensions from either curved side are 32 centimeters, the total width of bracket 20 is 20 centimeters, and the width of the curved portion is 2 centimeters.

FIG. 8 illustrates a top plan view of the first arm 27 of the bracket 10 wherein the top of device 20 is displayed to detail its dimensions which consists of 150 centimeters in length.

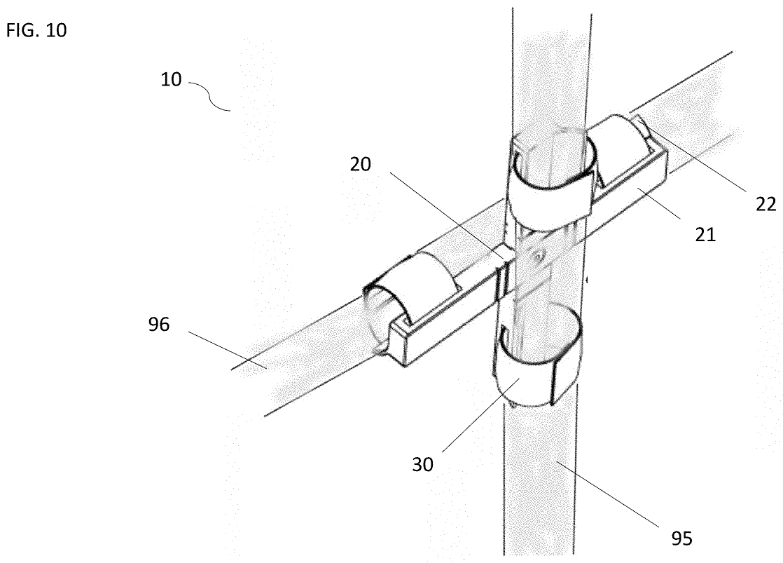

FIG. 9 illustrates a front view of the first arm 27 of the bracket 10 and further illustrating for the slots 21 of the device which are disposed to contain the flexible hook and loop fasteners 30. Additionally, a cavity, or channel 24 is illustrated for interlinking of the first arm 27 and second arm 28 and bevel 29 for rivet 23. Both the first arm 27 and second arm 28 possess a channel for symmetric mating.

In one embodiment, the height from the tip of the curved portion of the bracket to the base of the bracket is 18 centimeters in length, the length of the slots 21 for the hook and loop attachment straps 30 may be 30 centimeters in length, the distance between the slots 21, which are located on either side of the bracket 20, is 80 centimeters in length. Because of the curved fins 22 are disposed in an oppositely facing direction relative to one another, and as the two arms and the constituent components are identical, when the two arms are assembled by the common rivet 23, the ensuing assembly and design produces a universal or neutral attachment system and method. This opposed commonality assists in location and creation of tension and friction, which then works on conjunction with the hook and loop-based strap 30 to allow for sturdy suspension upon the poles of the chair to be utilized.

FIG. 10 illustrates the bracket 10 wherein it is pictured with a beach chair pole and beach umbrella pole attached to the device 20 to display the holes 21 in the device with the curved portion of the device 22 showing the hook and loop fastener around the frame of the beach chair 96 and beach umbrella pole 95.

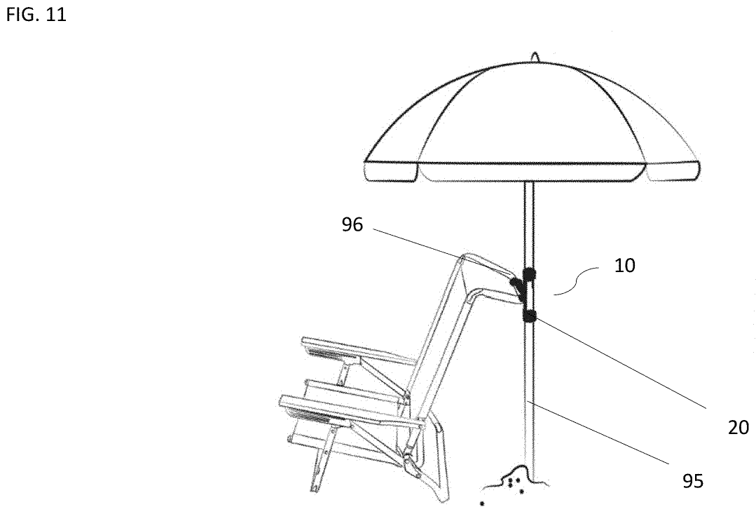

FIG. 11 illustrates the bracket 10 used to secure the beach chair 96 and the beach umbrella 97 together using the device 20 as to display the slots 21 in which the device is secured using the curved portion of the device 22 with a hook and loop fastener 30.

What is claimed is:

1. A removably attached weather protection system comprising:
a universally attachable bracket apparatus; and
a set of flexible joining mechanisms;
wherein at least one individual of the set of flexible joining mechanisms is disposed to communicate with a seating member and at least one individual of the set of flexible joining mechanisms is disposed to communicate with at least one weather protection member.

2. The removably attached weather protection system of claim 1 wherein the universal bracket apparatus comprises four arms.

3. The removably attached weather protection system of claim 1 wherein each of the four arms of the universal bracket apparatus comprises a through slot.

4. The removably attached weather protection system of claim 1 wherein the set of flexible joining mechanisms comprises at least two mechanisms.

5. The removably attached weather protection system of claim 3 wherein each individual of the set of joining mechanisms is disposed to pass through an individual of the slots in the bracket apparatus.

6. The removably attached weather protection system of claim 5 wherein at least one of each individual of the set of joining mechanisms is disposed to pass through an individual of the slots in the universal bracket apparatus and attach to a seating member and wherein and at least one of each individual of the set of joining mechanisms is disposed to pass through an individual of the slots in the universal bracket apparatus and attach to the at weather protection member in a manner to prevent the sunrays from hitting the space occupied by the seating.

7. A removably attached beach chair shading system comprising:
a universally attachable bracket apparatus further comprising:
a first arm comprising a channel;
a second arm comprising a channel; and
a rivet wherein the rivet is utilized to securely join the first arm and second arm; and
a set of flexible joining mechanisms;
wherein at least one individual of the set of flexible joining mechanisms is disposed to communicate with a seating member and at least one individual of the set of flexible joining mechanisms is disposed to communicate with at least one weather protection member.
